(19) United States
(12) Patent Application Publication
(10) Pub. No.: US 2026/0121693 A1
(43) Pub. Date: Apr. 30, 2026

(54) METHOD OF DESIGNING CODEBOOK FOR ADAPTIVE VEHICLE-TO-VEHICLE COMMUNICATION FOR ROAD STRUCTURE AND TRAFFIC CONDITION, AND APPARATUS FOR THE SAME

(71) Applicant: Seoul National University R&DB Foundation, Seoul (KR)

(72) Inventors: Keunwoo Kim, Seoul (KR); Seong-Cheol Kim, Seoul (KR)

(73) Assignee: Seoul National University R&DB Foundation, Seoul (KR)

(21) Appl. No.: 19/268,073

(22) Filed: Jul. 14, 2025

(30) Foreign Application Priority Data
Oct. 30, 2024 (KR) 10-2024-0150798

(51) Int. Cl. H04B 7/04; H04B 7/0426

(52) U.S. Cl. CPC H04B 7/04026; H04B 7/043

(57) ABSTRACT

Disclosed is a technique for designing a codebook for wireless communication between vehicles by executing a codebook design program on a codebook design apparatus. Based on a road structure, traffic parameter information, a mobility model, and a communication range R required for V2V communication, a vehicle distribution function representing the distribution of vehicles on the road is obtained. Based on the vehicle distribution function, beamwidths of the pattern to be generated by each codeword of the codebook are set. Then, codewords optimized for the hardware of the communication system of the vehicles on a road are designed based on an ideal beam pattern that generate the set beam width.

### CROSS-REFERENCE TO RELATED APPLICATION

This U.S. non-provisional application claims priority under 35 USC § 119 to Korean Patent Application No. 10-2024-0150798, filed on Oct. 30, 2024, in the Korean Intellectual Property Office (KIPO), the disclosure of which is incorporated by reference herein in its entirety.

### BACKGROUND

### 1. Technical Field

Example embodiments relate to a technology for inter-vehicle communication, and more particularly to a technology for designing a codebook applied to a vehicle-to-vehicle (V2V) communication system that supports communication between vehicles on the road.

### 2. Discussion of the Related Art

Autonomous driving has emerged as a promising technology that could revolutionize the transportation industry with its potential to reduce traffic congestion and improve road safety. One of the key considerations in the development and deployment of autonomous vehicles is their ability to communicate effectively with each other. In practical V2V communication systems, data rates of several Gbps are expected to be required to share visual signals, sensor data from inertial measurement units, wireless messages, etc. However, existing vehicle communication standards do not meet these requirements. On the other hand, communication systems operating in the millimeter wave (mmWave) band are considered an emerging technology for practical V2V communication systems due to their wide bandwidth. The millimeter-wave band experiences much higher path loss compared to the ultra-high frequency bands due to reduced antenna cross-section and increased atmospheric attenuation. The higher expected path loss may significantly degrade communication performance, requiring additional signal processing. Therefore, mmWave communication systems extensively use multiple-input multiple-output (MIMO) processing to achieve significant beamforming gains by utilizing directional signal transmission. In MIMO communication systems, multiple antennas are used to transmit data. By controlling the signal transmitted by each antenna, the signal may be focused in a specific direction, and this can transmit the signal more strongly toward the receiver that receives the signal.

When transmitting data in a wireless communication system, the data is converted into a specific signal pattern, and the signal pattern is called a codeword, and the list of codewords is called a codebook. In other words, the codebook defines which signal pattern to use for specific data. In a wireless communication environment, due to limited bandwidth and power constraints, not all possible signals may be used when transmitting data. The codebook optimizes data transmission by selecting the most efficient signal pattern. In addition, in a wireless communication environment, signals may be distorted or lost, so if a codebook is used, for example, a specific codeword may be designed to be sufficiently distinguished from other codewords, allowing the original data to be restored even if an error occurs.

Because of these advantages of codebooks, codebook-based beam alignment schemes are widely used in mmWave communication systems because they can easily obtain effective transmission beamformers, although they are suboptimal. Beam alignment systems require a predefined set of beamforming codewords to facilitate both channel integrity and data transmission. For example, LTE and new radio (NR) use codebooks built on the basis of discrete Fourier transform (DFT) codebooks that generate equally spaced beam patterns in the spatial frequency domain. Non-patent document 1 below proposes a beam design algorithm that generates beam patterns that cover equally spaced beam areas in the two-dimensional spatial frequency domain. In addition, non-patent document 2 presents a multi-resolution codebook design method in which each codeword of a specific level covers the same angular range. In addition, non-patent documents (3) and (4) propose an adaptive beam design strategy for vehicle-to-infrastructure (V2I) networks considering the statistical distribution of vehicles in a road environment and a codebook design framework for reconfigurable intelligent surface-supported V2V networks, respectively.

However, the codebooks according to the prior arts are configured to generate a beam pattern within a beam area with an equal spacing without considering the beam width adjustment of the beam pattern of each codeword. That is, in the case of the existing codebooks for MIMO communication, the codebooks are designed to generate a beam pattern with an equal beam width under the assumption that all transmitters and receivers are uniformly distributed in space. A codebook composed of codewords with an equal beam width may be useful in an environment where users are uniformly distributed in the spatial frequency domain, such as a cellular network. However, a codebook with an equal spacing of beam widths may not be suitable for beamforming in the V2V network. This is because the spatial frequency distribution among vehicles on the road is not uniform. In a V2V communication environment, each vehicle exists only in a specific space, the roadway, so using a pattern with a uniform beam width results in inefficient communication. As such, the prior arts do not provide specific teachings on how to analyze the statistical distribution of V2V direct communication links considering realistic road and traffic environments such as crossroads, roundabouts, etc. to enable efficient communication.

### SUMMARY

It is an object of the present invention to provide a codebook design method and a codebook design apparatus capable of supporting efficient V2V communication by creating codewords based on prior information on road structures and traffic conditions for efficient V2V communication.

The problem to be solved by the present invention is not limited to the problems described above, and may be expanded in various ways without departing from the spirit and scope of the present invention.

According to embodiments to achieve the object of the present invention, a method for designing a codebook for wireless communication between vehicles executes a codebook design program in a codebook design apparatus. The codebook design method includes obtaining a vehicle distribution function representing distribution of vehicles on a road based on a road structure, traffic parameter information, a mobility model, and a communication range R required for V2V communication; setting a beam width of a beam pattern to be generated by each codeword of a codebook based on the obtained vehicle distribution function; and designing codewords optimized for hardware of a V2V communication system installed in each of vehicles on a road based on a beam pattern that generates the set beam width.

According to example embodiments, the vehicle distribution function may be a cumulative distribution function (CDF) or a probability density function (PDF) of vehicles existing on the road.

According to example embodiments, the ‘obtaining a vehicle distribution function’ may include: obtaining an average number of vehicles existing within a circle with a radius R centered on a transmitting vehicle on a road by applying a mobility model expressed by specific traffic parameters; obtaining an average number of vehicles existing within a sector area with the radius R and a central angle of θ centered on the transmitting vehicle; and obtaining the CDF representing a probability that vehicles exist within the central angle θ centered on the transmitting vehicle by dividing the average number of vehicles existing within the sector area by the average number of vehicles existing within the circle.

According to example embodiments, the ‘obtaining the vehicle distribution function’ may further include obtaining the PDF representing a distribution probability density of vehicles according to the central angle θ by partially differentiating the obtained CDF with respect to the central angle θ of the sector area.

According to example embodiments, the CDF and/or the PDF may be obtained separately for a plurality of road structures including a straight road, a L-corner road, a T-corner road, a crossroad, and a roundabout.

According to example embodiments, the ‘setting a beamwidth of a beam pattern’ may include setting a relatively thinner beam width in a direction in which a probability of vehicle existence is relatively high, and a relatively wider beam width in a direction in which the probability of vehicle existence is relatively low, based on the CDF according to the central angle θ.

According to example embodiments, the method may further include constructing a codebook by grouping codewords designed in the designing codewords into the codebook.

According to example embodiments, the ‘setting a beamwidth of a beam pattern’ may include dividing an entire angular range of azimuth into a plurality of beam width angles centered on the transmitting vehicle, and setting the plurality of beam width angles such that all average numbers of vehicles existing probabilistically within respective angular ranges of all divided angles are the same.

According to example embodiments, the codeword that generates the set beam width may be designed using an orthogonal propagation method (OPM) algorithm.

According to example embodiments, the traffic parameter information may be information obtained by a sensor unit of the codebook design apparatus sensing and analyzing a traffic situation of vehicles on surrounding roads in real time.

Meanwhile, according to embodiments to achieve the object of the present invention, a codebook design apparatus applicable to a V2V wireless communication is provided. The codebook design apparatus includes a vehicle detection sensor unit, a storage unit, and an operation control unit. The vehicle detection sensor unit is configured to sense traffic conditions of vehicles on surrounding roads in real time. The storage unit is configured to store a codebook design program, traffic parameter data detected by the vehicle detection sensor unit, information set with respect to a structure of surrounding roads, a mobility model, and communication range R required for the V2V wireless communication. The operation control unit is configured to execute the codebook design program for performing tasks of obtaining a vehicle distribution function representing distribution of vehicles on a road based on the traffic parameter data detected in real time, and the information set with respect to a structure of surrounding roads, a mobility model, and communication range R; setting a beam width of a beam pattern to be generated by each codeword of a codebook based on the obtained vehicle distribution function; and designing codewords optimized for the hardware of a V2V communication system installed on vehicles on the road based on an ideal beam pattern that creates the set beam width, so that the codebook is adaptively designed according to the road structure and traffic conditions.

According to example embodiments, the codebook design apparatus may further include a communication unit configured to support wireless communication with wireless communication systems installed in vehicles on surrounding roads, wherein the operation control unit may be configured to execute the codebook design program for further performing tasks of grouping designed codewords to construct a codebook and broadcasting the codebook to vehicles on surrounding roads through a communication unit so that the codebook can be applied to the vehicles.

According to example embodiments, the vehicle distribution function may be a CDF or a PDF of vehicles existing on the road.

According to example embodiments, the ‘obtaining a vehicle distribution function’ may include obtaining an average number of vehicles existing within a circle with a radius R centered on a transmitting vehicle on a road by applying a mobility model expressed by specific traffic parameters; obtaining an average number of vehicles existing within a sector area with the radius R and a central angle of θ centered on the transmitting vehicle; and obtaining the CDF representing a probability that vehicles exist within the central angle θ centered on the transmitting vehicle by dividing the average number of vehicles existing within the sector area by the average number of vehicles existing within the circle.

According to example embodiments, the ‘obtaining the vehicle distribution function’ further comprises obtaining the PDF representing a distribution probability density of vehicles according to the central angle θ by partially differentiating the obtained CDF with respect to the central angle θ of the sector area.

According to example embodiments, the CDF and/or the PDF may be obtained separately for a plurality of road structures including a straight road, a L-corner road, a T-corner road, a crossroad, and a roundabout.

According to example embodiments, the ‘setting a beamwidth of a beam pattern’ may include setting a relatively thinner beam width in a direction in which a probability of vehicle existence is relatively high, and a relatively wider beam width in a direction in which the probability of vehicle existence is relatively low, based on the CDF according to the central angle θ.

According to example embodiments, the ‘setting a beamwidth of a beam pattern’ may include dividing an entire angular range of azimuth into a plurality of beam width angles centered on the transmitting vehicle, and setting the plurality of beam width angles such that all average numbers of vehicles existing probabilistically within respective angular ranges of all divided angles are the same.

According to the example embodiment of the present invention, a codebook design framework is proposed which is specialized for V2V communication in millimeter wave spectrum based on analysis of channel direction distribution between vehicles. The codebook design framework provided according to example embodiments of the present invention effectively assigns different beam widths to each codeword according to the surrounding road structure and current traffic conditions in the vehicle-to-vehicle communication situation in the codebook design. While the codebook used in the conventional technology is designed to have a constant beam width in all directions, the codebook according to the present invention is designed to have a thinner beam width in a direction where the probability of vehicle presence is relatively high and a wider beam width in a direction where the probability of vehicle presence is relatively low. The vehicle-to-vehicle communication system using such a codebook can transmit stronger signals to more vehicles, thereby enabling more efficient vehicle-to-vehicle communication than the conventional one throughout the V2V communication system, thereby securing a higher data transmission rate and higher communication stability.

In addition, the directions where the probability of vehicle presence is high are usually the front and rear of the transmitting vehicle, and the distance from the transmitting vehicle to the receiving vehicle is longer in these two directions than in the directions on both sides of the transmitting vehicle, so that signal attenuation occurs prominently. If a stronger signal is sent to the front and rear of the transmitting vehicle, signal attenuation can be compensated for, thereby increasing the data transmission amount, thereby further increasing the stability of the communication system.

The present invention has the advantage of being able to be flexibly linked with conventional technologies conceived under the assumption that an ideally designed codebook exists, and thus can be directly applied to a real environment.

### BRIEF DESCRIPTION OF THE DRAWINGS

FIG. 1 is a diagram to illustrate mmWave V2V communication between vehicles traveling on a straight road.

FIG. 2 illustrates a configuration of a V2V communication system installed in a transmitting vehicle and a receiving vehicle.

FIG. 3 is a block diagram of a hybrid beamforming system established during mmWave wireless communication via a V2V communication system between a transmitting vehicle and a receiving vehicle.

FIG. 4 is a flowchart illustrating the logic of an algorithm for designing a codebook for V2V communication according to an example embodiment of the present invention.

FIG. 4 is a flow diagram illustrating the logic of an algorithm for designing a codebook for V2V communication according to an example embodiment of the present invention.

FIG. 5 is a block diagram illustrating a configuration of an apparatus for designing a codebook for V2V communication according to an example embodiment of the present invention.

FIG. 6 illustrates various road structures that may utilize the codebook for V2V communication according to an example embodiment of the present invention.

FIG. 7 is a flowchart illustrating a process of deriving (step S200 of FIG. 4) a function representing the distribution of vehicles on a road according to an example embodiment of the present invention.

FIG. 8 illustrates a case in which a circle with a radius of R is drawn around a transmitting vehicle in a road environment where L lanes and L_{I} lanes intersect at a predetermined angle, as an example.

FIG. 9 illustrates a plan view of a straight road with a single lane to describe obtaining a probability density function of vehicles.

FIG. 10 shows comparisons of the approximate PDF obtained according to the present invention and the empirical PDF obtained according to the prior art for various road structure types such as a straight road, L-corner, a crossroad and outside roundabout, and an inside roundabout.

FIG. 11 shows change of the frequency efficiency according to the numbers of codewords, RF chains, and antennas.

### DETAILED DESCRIPTION OF THE EMBODIMENTS

Hereinafter, with reference to the attached drawings, preferred embodiments of the present invention will be described in more detail. The same reference numerals are used for the same components in the drawings, and duplicate descriptions of the same components are omitted.

Regarding the embodiments of the present invention disclosed in this specification, specific structural and functional descriptions are only exemplified for the purpose of explaining the embodiments of the present invention. The embodiments of the present invention may be implemented in various forms, and should not be construed as being limited to the embodiments described in the specification. That is, the present invention may have various modifications and may have various forms, and specific embodiments are exemplified in the drawings and described in detail in the specification. However, this is not intended to limit the present invention to a specific disclosed form, and should be understood to include all modifications, equivalents, or substitutes included in the spirit and technical scope of the present invention.

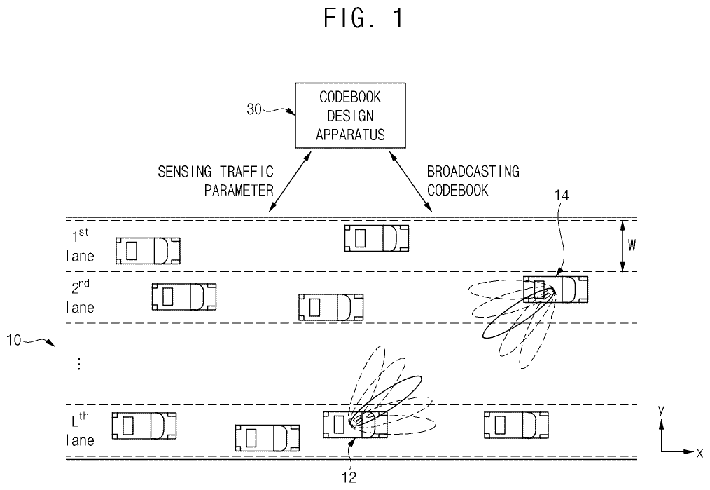

FIG. 1 is a diagram for illustrating mmWave V2V communication between vehicles driving on a straight road with L lanes, for example. Consideration is given to mmWave V2V communication systems operating on various roadway structures, such as a straight lane, an crossroad, and a roundabout. In a V2V wireless network, a transmitting vehicle 12 may wirelessly transmit a single data stream to a receiving vehicle 14, as shown in FIG. 1, and the receiving vehicle 14 may the signal. To this end, the transmitting vehicle 12 and the receiving vehicle 14 may be equipped with a system that supports mmWave V2V communication.

In addition, a codebook design apparatus 30 according to an example embodiment of the present invention may be present at a fixed location around a road 10. The codebook design apparatus 30 may design a codebook in the following process. First, based on prior information about the road structure and traffic conditions, an angular distribution between vehicles located on the road is derived. Second, by utilizing the derived vehicle angular distribution, a codeword is designed to generate a beam pattern having a thinner beam width in a direction where the probability of vehicles existing is relatively high, and a wider beam width in a direction where the probability of vehicles existing is relatively low. A detailed description thereof will be described later.

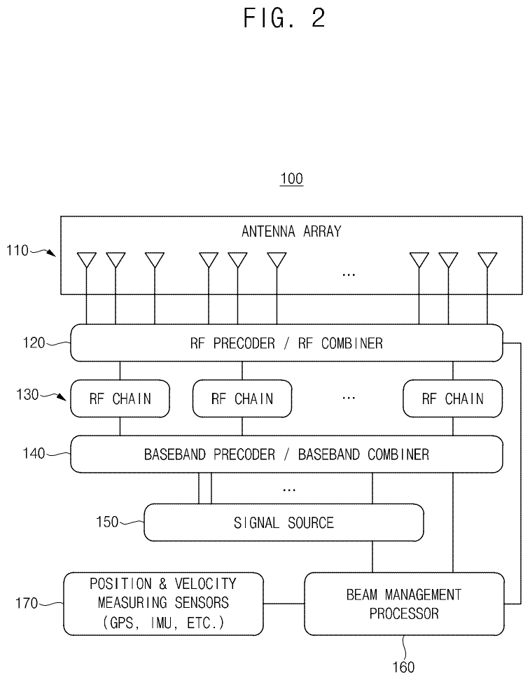

FIG. 2 shows a block diagram showing the configuration of a V2V communication system installed in a transmitting vehicle and a receiving vehicle that perform a V2V communication beam management method according to an example embodiment.

Referring to FIG. 2, a V2V communication system 100 may include a multi-antenna array and several components for supporting V2V communication. Specifically, the V2V communication system 100 may include, in addition to an antenna array unit 110 including a plurality of antennas, a radio frequency (RF) precoder/RF combiner 120, an RF chain unit 130, a baseband precoder/combiner 140, a signal source unit 150, a beam management processor 160, and a position and velocity measuring sensor unit 170. The V2V communication system 100 may be a communication system operating in a millimeter wave band.

The antenna array unit 110 may generally include a plurality of antenna elements. The antenna array unit 110 may physically transmit/receive a wireless beam training signal exchanged between a transmitting unit and a receiving unit. The antenna array unit 110 may be, for example, a uniform linear array (ULA) or a uniform planar array (UPA) configured to perform MIMO. The MIMO antenna array is a combination of multiple antennas in an array form, and may be used to perform beam forming, signal arrival angle estimation, etc. The antenna array unit 110 may be preferably mounted at a location with the least path loss of wireless signals and communication interference, such as on the roof of a vehicle.

The RF precoder/RF combiner 120 may be a module including a low noise amplifier (LNA) for the receiving unit Rx, a power amplifier (PA) for the transmitting unit Tx, an analog phase shifter, etc. The RF precoder/RF combiner 120 may perform precoding/combining using the digital signal of the baseband precoder/combiner 140 input from each RF chain of the RF chain unit 130. The RF precoder or RF combiner 120 may provide an analog signal for wireless transmission generated through the precoding/combining to the antenna array unit 110, and may be also provided with a signal received through the antenna array unit 110. The RF precoder/RF combiner 120 may be directly connected to the beam management processor 160.

The RF chain unit 130 may include a plurality of RF chains. The plurality of RF chains may be respectively connected to the RF precoder/RF combiner 120 and the baseband precoder/combiner 140. Each RF chain of the RF chain unit 130 may be implemented by combining an analog-to-digital converter (ADC) Rx, a digital-to-analog converter (DAC) Tx, an RF processor, a local oscillator, a mixer, etc. The RF chain unit 130 may transfer a digital signal of the baseband precoder/combiner 140 to an RF precoder/RF combiner 120.

The baseband precoder/combiner 140 may be connected between the RF chain unit 130 and the signal source unit 150, and may also be connected between the RF chain unit 130 and the beam management processor 160. A digital signal for beam forming may be generated using data provided from the signal source unit 150 and the beam management processor 160.

The signal source unit 150 may generate data to be exchanged between the transmitting unit Tx and the receiving unit Rx under the control of the beam management processor 160. The data to be exchanged between the transmitting unit Tx and the receiving unit Rx may also include the vehicle position and velocity information and the position information of the antenna array unit 110, which are input from the beam management processor 160.

The beam management processor 160 may be a module that actually executes a computer program in which a predetermined beam management algorithm is implemented. The beam management processor 160 may perform beam forming and beam management by controlling the baseband precoder/combiner 140 and the RF precoder/RF combiner 120 using the position and velocity information of its own vehicle acquired from the position and velocity measuring sensor unit 170 and the position and velocity information of the communication partner vehicle acquired through the antenna array unit 110. To this end, the beam management processor 160 may be connected to the signal source unit 150, the baseband precoder/combiner 140, and the RF precoder/RF combiner 120, respectively. The beam management processor 160 may exchange information (improved angle information, beam forming weight, etc.) necessary for beam forming and beam management through the connected passage.

The beam management processor 160 may be implemented using one or more general-purpose computers or special-purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing and responding to instructions. Computer programs and data executed by the beam management processor 160 may be stored in a computer-readable nonvolatile recording medium (not shown).

The position and velocity measuring sensor unit 170 may be installed for each vehicle. The position and velocity measuring sensor unit 170 may include a position sensor that measures the position of a reference point of a vehicle, and a velocity sensor that measures the velocity of the vehicle. The position and velocity measuring sensor unit 170 may provide the position and velocity information of the reference point of the vehicle measured by the corresponding sensor to the beam management processor 160. Vehicles performing V2V communication may share raw measurement data such as the reference point position and velocity data of each vehicle measured by each position and velocity measuring sensor unit 170. The position sensor may be implemented using, for example, a GPS sensor, but is not necessarily limited thereto. The velocity sensor may be implemented using, for example, an inertial measurement unit (IMU), but is not necessarily limited thereto.

The mm Wave V2V communication system 100 as described above may support both the transmission and reception functions of mmWave wireless signals. When the mmWave V2V communication system 100 is installed in each vehicle, each of such vehicles may be a transmitting vehicle that transmits mm Wave wireless signals and may also be a receiving vehicle that receives mmWave wireless signals.

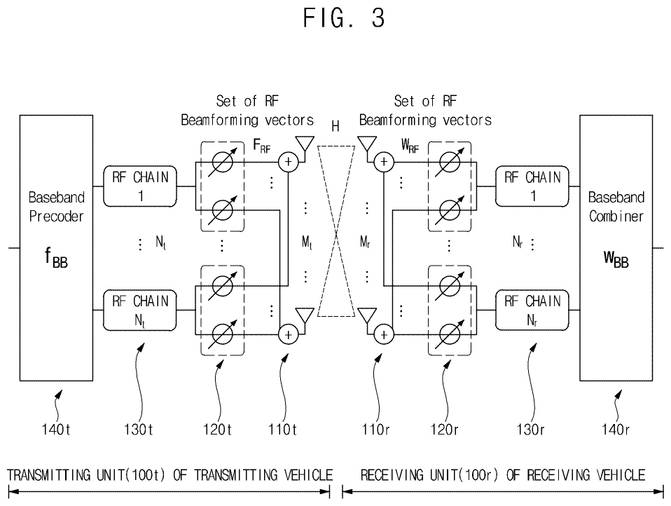

FIG. 3 illustrates a block diagram of a hybrid beam forming system established during mmWave wireless communication between a transmitting vehicle and a receiving vehicle via a mmWave V2V communication system.

Referring to FIG. 3, a transmitting unit 100t of the V2V communication system 100 installed in the transmitting vehicle 12 may include a baseband precoder 140t, a first RF chain unit 130t, a first RF precoder 120t, and a transmitting antenna array 110t. A receiving unit 100r of the V2V communication system 100 installed in the receiving vehicle 14 may include a receiving antenna array 110r, a second RF combiner 120r, a second RF chain unit 130r, and a baseband combiner 140r.

In the transmitting unit 100t, the transmitting antenna array 110t may include Mₜ transmitting antennas, and the first RF chain unit 130t may include Nₜ RF chains. Each of the Mₜ transmitting antennas may be fully connected to all of the Nₜ RF chains via the first RF precoder 120t. The first RF precoder 120t may include, for example, Nₜ phase shifters (not shown) and Nₜ amplifiers (not shown). In the receiving unit 100r, the receiving antenna array 110r may include Mᵣ receiving antennas, and the second RF chain unit 130r may include Mᵣ RF chains. And each of the Mᵣ receiving antennas may be fully connected to all of the Mᵣ RF chains via the second RF combiner 120r. The second RF combiner 120r may include Mₜ low-noise amplifiers (not shown) and Nₜ phase shifters. Here, Nₜ, Mₜ, Nᵣ, and Mᵣ are natural numbers greater than or equal to 2. The transmitting and receiving antenna arrays 110t, 110r may be mounted at a location where the path loss of a wireless signal and communication interference are the smallest, for example, on the roof of a vehicle. A plurality of RF chains of the first RF chain unit 130t may be connected to the baseband precoder 140t, and a plurality of RF chains of the second RF chain unit 130r may be connected to the baseband combiner 140r.

The baseband precoder 140t may generate a digital signal for beamforming using source signal data. Each RF chain of the first RF chain unit 130t may perform precoding using a digital signal corresponding to an intermediate frequency signal provided from the baseband precoder 140t to generate analog RF signals to be wirelessly transmitted through each transmission antenna. The analog RF signals may be appropriately phase-shifted and amplified for each antenna by the phase shifters and amplifiers of the first RF precoder 120t and wirelessly transmitted through the antennas of the transmitting antenna array 110t.

Signals wirelessly received through the receiving antenna array 110r may be provided to each RF chain of the second RF chain unit 130r in a phase-shifted state by the second RF combiner 120r. Each RF chain of the second RF chain unit 130r may amplify and decode the received signals, and the decoded signals may be transmitted to the baseband combiner 140r and combined.

Next, the system model of mmWave V2V wireless communication is described. In the following description, [symbol] is the field of complex numbers, [symbol] is the field of real numbers, [symbol] (m, σ²) is the complex normal distribution with mean m and variance σ², 0ₐ is the a×1 all zeros column vector, I_{M} is the M×M identity matrix, E[·] is the expectation operator, |·| is the norm, and ∥·∥_{F} is the Frobenius norm, respectively. Also, A⁻¹, A^{H}, and A(a, b) denote inverse, conjugate transpose, and (a, b)-th entry of the matrix A, respectively. Lastly, A∩B and A∪B denote the crossroad and union of events A and B, A^{c} denotes the complement of A, and P(A) is the probability of an event A.

In an mm Wave V2V communication environment, assuming a narrowband block fading channel model, the receiving vehicle 14 may observe the signal vector of Eq. (1)

$$y = \sqrt{ρ} Hfs + n \qquad ( 1 )$$

where s represents the transmit symbol with a power constraint of [symbol] [|s|²]=1, H∈ [symbol] ^{M}^{_{i×M}}^{ᵢ} represents the channel matrix, and n˜ [symbol] ( [symbol] ) denotes the vector of normalized additive white Gaussian noise (AWGN). The average signal-to-noise ratio (SNR) per antenna is denoted by ρ and expressed as

$$ρ ≐ \frac{P}{{σ}^{2}} {( \frac{λ}{4 π d} )}^{n} ,$$

where P represents the transmit power, σ² denotes the noise power, λ represents the wavelength, d represents the distance between the transmitting vehicle 12 and the receiving vehicle 14, and η represents the path loss exponent.

The beamforming vector may be constructed as f=F_{RF}f_{BB}, where F_{RF}∈ [symbol] ^{M}^{_{i×N}}^{ₜ} is the set of RF beam vectors and f_{BB}∈ [symbol] ^{N}^{_{t×1}} is a baseband precoder. The receiving vehicle 14 may combine the received signal vector in Eq. (1) by using the combining vector w=W_{RF}W_{BB}, where W_{RF}∈ [symbol] ^{M}^{_{i×N}}^{ᵢ} is the set of RF beam steering vectors, and W_{BB}∈ [symbol] ^{N}^{_{i×1}} is the baseband combiner. In the baseband combiner 140r, the signal combining process generates the received symbol z=\sqrt{ρ}w^{H}Hfs+w^{H}n. The beamforming and combining vectors are normalized as

$${‖ f ‖}_{2}^{2} = {‖ {F}_{RF} {f}_{BB} ‖}_{2}^{2} = 1 and {‖ w ‖}_{2}^{2} = {‖ {W}_{RF} {w}_{BB} ‖}_{2}^{2} = 1.$$

In the V2V communication systems, the transmitting unit 100t and the receiving unit 100r of the transmitting vehicle 12 and the receiving vehicle 14 may conduct the codebook-based beam alignment, before transmitting the data symbol. The transmit codebook, [symbol] ={f₁, . . . , f_{Q}_{ₜ}}, may be composed of Qₜ codewords, where the qₜ-th codeword may be formed by combining Nₜ RF beam steering vectors with the baseband precoder 140t such as f_{q}_{ₜ}=F_{RF}_{ₜ}f_{BB,q}_{ₜ}, for Similarly, the receive codebook may be constructed as Qᵣ codewords, such as W={w₁, . . . , w_{Q}_{ₜ}}, where the qᵣ-th codeword is given by w_{q}_{ᵣ}=W_{RP,q}_{ᵣ}w_{BB,q}_{ᵣ}. The RF beam steering vectors are unit norm vectors restricted by equal gain constraints. During the beam-alignment process, the transmitting unit 100t and the receiving unit 100r of the transmitting vehicle 12 and the receiving vehicle 14 may choose an optimal codeword pair (f, \tilde{w})=(f_{q}_{ᵣ}, w_{q}_{ᵣ}), with the selected codeword indices given by Eq. (2).

$$\text{?} \qquad ( 2 )$$

$$\text{?} \text{indicates text missing or illegible when filed}$$

### Here,

$$\text{?}$$

$$\text{?} \text{indicates text missing or illegible when filed}$$

represents the (qₜ, qᵣ)-th received sounding sample obtained using the codeword pair (f_{q}_{ₜ},w_{q}_{ᵣ})∈ [symbol] × [symbol] , and n_{q}_{ₜ},qᵣ˜ [symbol] (0_{M}_{ᵢ},Iₘ_{ᵢ}) represents the AWGN vector.

The mmWave V2V communication channel may be modeled as a combination of a dominant line-of-sight (LoS) radio path and S non-line-of-sight (NLoS) radio paths. It is assumed that each scatterer may contribute a single radio path. Considering the practical sectorization of a uniform linear array (ULA) type transmitting and receiving antenna arrays 110t, 110r, it may be assumed that two ULAs are mounted on the center of the roof of the transmitting vehicle 12 and the receiving vehicle 14. One ULA covers the heading direction of the vehicle, i.e.

$$θ ∈ {ν}^{h} = ( 0 , \frac{π}{2} ] ⋃ ( \frac{\text{?}}{2} , 2 π ] ,$$

$$\text{?} \text{indicates text missing or illegible when filed}$$

and the other covers the backward direction of the vehicle, i.e.

$$θ ∈ {ν}^{h} = ( \frac{π}{2} , \frac{3 π}{2} ] .$$

Here, θ∈(0, 2π] denotes the azimuth angle, and θ=0 represents the heading direction of the vehicle. Assuming a half-wavelength antenna spacing, the ray-like radio path may be defined using the array response vector

$${a}_{{M}_{a}} ( θ ) = {\frac{1}{{M}_{a}} [ 1 , {e}^{j π sin ( θ )} , … , {e}^{j π ( {M}_{a} - 1 ) sin ( θ )} ]}^{T} ,$$

where Mₐ indicates the number of antenna elements. Considering the sparse nature of the mm-Wave channels, the channel matrix may be expressed as in Eq. (3).

$$H = \sqrt{\frac{{M}_{t} {M}_{r} K}{1 + K}} {e}^{j \frac{2 π d}{λ}} {a}_{{M}_{r}} ( {θ}_{r , 0} ) \text{?} ( {θ}_{t , 0} ) + \sqrt{\frac{{M}_{t} {M}_{r}}{S ( 1 + K )}} {\sum }_{s = 1}^{S} \text{?} \qquad ( 3 )$$

$$\text{?} \text{indicates text missing or illegible when filed}$$

In Eq. (3) above,

$${e}^{j \frac{2 π d}{λ}}$$

represents the phase shift originating from the distance between the transmitting vehicle 12 and the receiving vehicle 14, K denotes the Rician K-factor, αₛ˜ [symbol] (0, 1) denotes the complex channel gain of the NLOS radio path, and α_{M}_{ₜ}(θₜ) and α_{M}_{ᵣ}(θᵣ) represent the antenna array response vectors of the transmitting vehicle 12 and the receiving vehicle 14, respectively. Here, θ_{t,0} and θ_{r,0} denote the azimuth angle of departure (AoD) and angle of arrival (AoA) of the dominant radio path, respectively. Furthermore, θ_{t,s}∈(0, 2π] and θ_{r,s}∈(0, 2π] denote the AoD and AoA of the s-th NLOS radio path, respectively. In embodiments of the present invention, it is assumed that the AoD and AoA of NLOS radio paths are uniformly distributed.

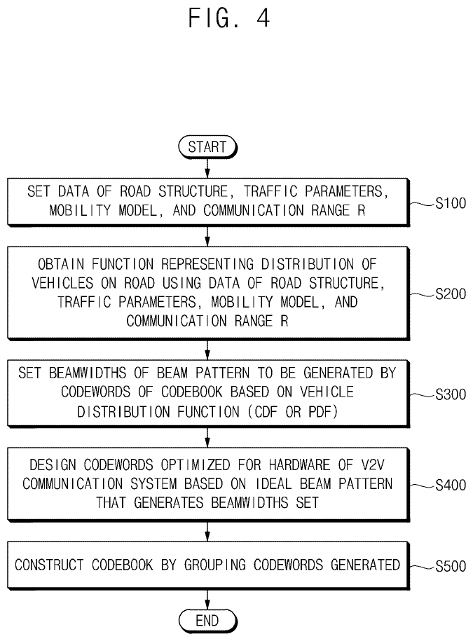

The flowchart of FIG. 4 shows a design algorithm of a codebook for V2V communication according to an example embodiment of the present invention.

The codebook design algorithm of the example embodiment is an algorithm for configuring a codebook to set the beam width of a wireless communication signal between vehicles differently based on the distribution of surrounding vehicles along the azimuth direction in V2V vehicle communication. The beam width may be set adaptively according to the road structure and traffic environment. For example, in the case of a straight road, a codeword that can assign a narrow but strong beam in the direction of vehicle travel (x-axis direction) and a wide but weak beam in the direction orthogonal to the direction of travel (y-axis direction) may be used. In the case of a crossroad, since vehicles have a similar probability of existing in the x-axis direction as well as the y-axis direction on average, a codeword that can assign beams of similar width and intensity in the y-axis direction as well as the x-axis direction may be used. The width and intensity of the beam can be designed adaptively by considering not only the direction of vehicle travel but also the number and location of lanes. This codebook design algorithm may be implemented as a computer program.

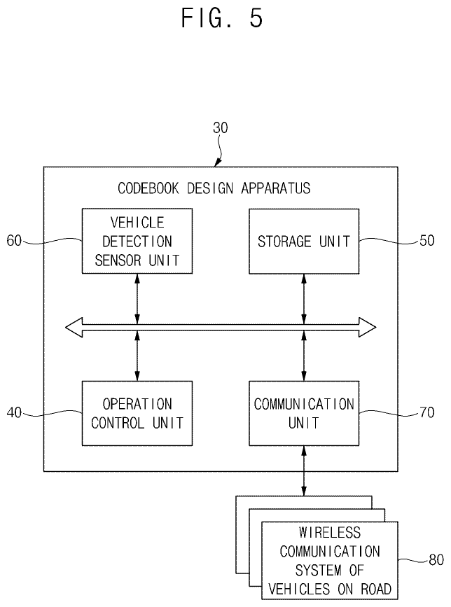

FIG. 5 schematically illustrates the configuration of an apparatus for designing a codebook for V2V communication according to an example embodiment of the present invention.

Referring to FIG. 5, the codebook design apparatus 30 may include an operation control unit 40, a storage unit 50, a vehicle detection sensor unit 60, and a communication unit 70.

The vehicle detection sensor unit 60 may include sensors (e.g., a camera, a vehicle detection sensor, etc.) that can sense vehicles driving on surrounding roads in real time and obtain information on traffic parameters of the vehicles, such as traffic volume for each lane, vehicle spacing, or vehicle density.

The communication unit 70 may include a communication module that supports wireless communication with wireless communication systems 80 installed on vehicles on surrounding roads.

The storage unit 50 may store a computer program for designing a codebook according to an example embodiment of the present invention, data on traffic parameters sensed by the vehicle detection sensor unit 60, data on road structures, mobility models, and the range R of a communication area, etc. The storage unit 50 may be composed of nonvolatile data storage means, such as magnetic media such as hard disks, floppy disks, and magnetic tapes, optical media such as CD-ROMs and DVDs, magneto-optical media such as floptical disks, and ROMs, RAMs, flash memories, etc.

The operation control unit 40 may be a device that can execute an operating system (OS) and one or more computer programs executed on the operating system, such as a codebook design program stored in the storage unit 50, and a control program that can control the operations of the storage unit 50, the vehicle detection sensor unit 60, and the communication unit 70. The codebook design program may also include a function that can analyze traffic parameter data detected by the vehicle detection sensor unit 60 to extract traffic parameter values. The one or more computer programs may include a computer program for codebook design implemented based on a codebook design algorithm according to an example embodiment of the present invention described below. The operation control unit 40 may be implemented using one or more general-purpose computers or special-purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing and responding to instructions.

The codebook design apparatus 30 having such a configuration may be installed as a component of, for example, roadside base stations (RSUs) installed along roads and/or communication base stations operated by a communication service agency. The codebook design apparatus 30 may perform wireless communication with vehicles equipped with a mmWave communication system 80 that travel on the surrounding roads. Of course, the codebook design apparatus 30 may be configured to be operated as a separate independent device and installed along a road.

Referring again to FIGS. 4 and 5, the operation control unit 40 reads and executes a computer program for codebook design, a computer program for traffic parameter analysis, and other programs for controlling the storage unit 50, the vehicle detection sensor unit 60, the communication unit 70, etc. from the storage unit 50, thereby performing various processing tasks for codebook design described below.

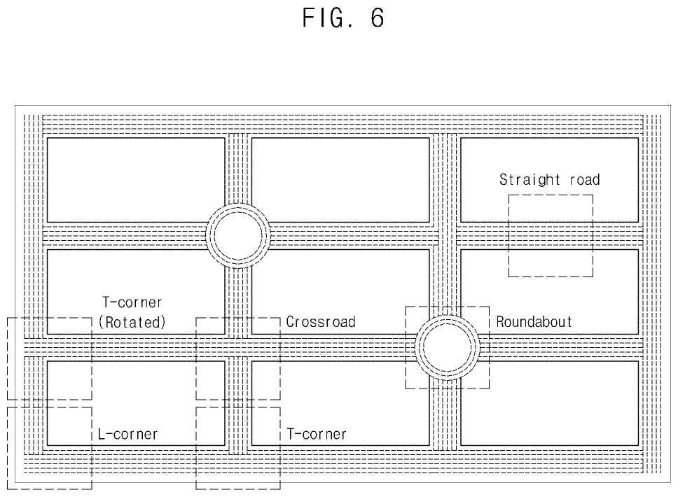

First, as a basic task for codebook design, data of the road structure, traffic parameters, mobility model, and communication range R (i.e., the radius of the communication area) required for V2V communication may be set (step S100). Information about the structure of the road on which vehicles drive, the mobility model, and the radius R of the communication area may be given as known values. FIG. 6 illustrates various road structures that can utilize the codebook for V2V communication according to an example embodiment of the present invention. As illustrated in FIG. 6, the present invention can be applied to various road structures such as a straight road, an L-corner, a T-corner, a T-corner (rotated), a crossroad, and a roundabout. Road structure information is information about the type of road on the section of road on which the vehicle is currently driving. Traffic parameter information (e.g., traffic volume information, vehicle spacing and density information) about vehicles on the road may be obtained by analyzing data sensed in real time by the vehicle detection sensor unit 60 (e.g., images of vehicles on the road captured by a camera). The operation control unit 40 transmits the data about these to the codebook design program so that they can be set. This information can be sensed in real time using a camera and/or a vehicle detection sensor. The radius R value of the communication area may be determined according to the desired communication performance based on the V2V communication coverage of the V2V communication system being used, and can be set to a value that is at least equal to or greater than the minimum communication coverage required between one vehicle and another vehicle. The mobility model is a distribution model of vehicles on the road. For example, the number of vehicles passing through a lane at a certain point in time can be set as a Poisson model that follows the Poisson distribution.

Next, the operation control unit 40 may obtain a function representing the distribution of vehicles on the road using the set values of the road structure, traffic parameters, mobility model, communication range R, etc. (step S200). In one embodiment, the function representing the distribution of vehicles may be a CDF. In another embodiment, the distribution function of vehicles may be a PDF. The PDF can be obtained by differentiating the CDF. Therefore, the CDF of vehicles may be first obtained, and then the PDF of vehicles may be derived by differentiating it.

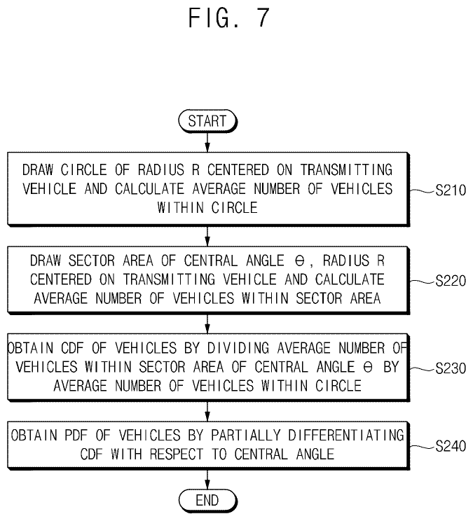

FIG. 7 specifically shows a process of deriving a distribution function of vehicles on the road (i.e., step S200 of FIG. 4) according to an example embodiment.

Referring to FIG. 7, first, an average number of vehicles within a circle of radius R centered on the transmitting vehicle 12 may be calculated (step S210). Assuming a situation where specific vehicles are each located on a straight lane, the number of vehicles per unit area can be obtained by applying a mobility model expressed by specific traffic parameters. For example, if a Poisson mobility model is applied, the average number of vehicles per unit area can be determined by traffic parameters such as average vehicle speed and inter-vehicle time.

It can be assumed that vehicles are on a specific road structure. Here, the specific road structure may include the straight road, the L-corner, the T-corner, the crossroad, the roundabout, etc. The present invention can be applied to all of these types of road structures. The traffic parameters applied to each lane for each road structure may be different, and the average number of vehicles per unit area for each lane may also be different.

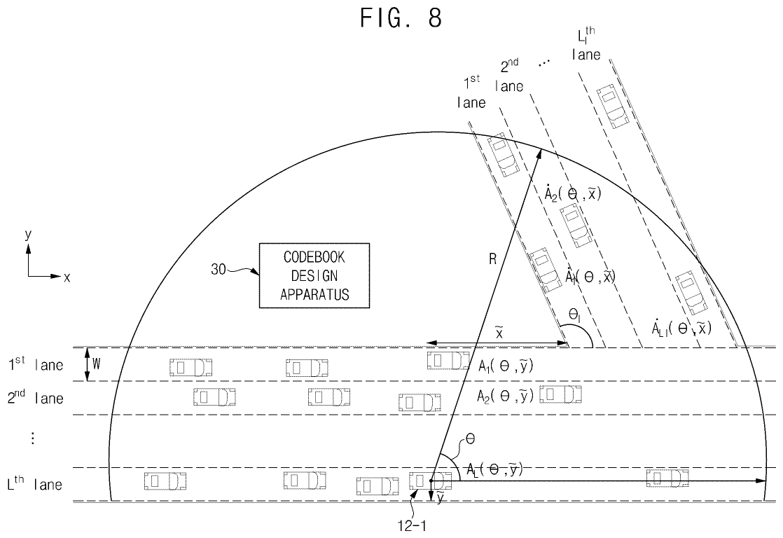

FIG. 8 shows a road environment where L lanes and L_{I} lanes intersect at a predetermined angle as an example. In such an arbitrary road structure, it may be assumed that one vehicle among the vehicles on the road is a transmitting vehicle 12-1. In this assumption, a circle of radius R centered on the transmitting vehicle 12-1 may be drawn, and an average number of vehicles existing in the circle can be obtained. Here, R means the communication range required for V2V communication.

Then, a sector area with a radius R centered on the transmitting vehicle 12-1 and a central angle θ can be drawn, and an average number of vehicles existing in the sector area may be calculated (step S220). That is, the average number of vehicles existing in a sector area with a central angle θ∈[0, 2π] within a circle with a radius R centered on the transmitting vehicle 12-1 can be obtained as a function of the central angle θ.

The average number of vehicles existing in the sector area of the central angle θ obtained in step S220 may be divided by the average number of vehicles existing in the circle obtained in step S210 to obtain the CDF of the vehicles (step S230). That is, the average number of vehicles existing in the sector is divided by the average number of vehicles existing in the circle. Through this, the CDF of other vehicles to be present probabilistically in the central angle θ centered on the transmitting vehicle can be obtained.

The CDF obtained in this way may be partially differentiated with respect to the central angle θ of the sector area to obtain the PDF of the vehicles (step S240). The PDF according to 0 in various road structures such as straight roads, crossroads, and roundabouts can be obtained in the same way.

The process of deriving the CDF and PDF of the vehicles will be explained in more detail. The spatial characteristics of the V2V communication system can be analyzed based on the model of the V2V communication system described above. The main idea of the codebook design framework according to the example embodiment is to adaptively allocate the beamwidth of the beam pattern for each codeword based on the analysis of the angular distribution of the dominant radio path between vehicles by exploiting the spatial characteristics of the road environment. To this end, the statistical features of the vehicles may be analyzed to develop a model that can capture the spatial characteristics of V2V channels.

First, the traffic density on a single lane may be analyzed. To simplify the analysis of spatial distribution of vehicles on a single lane, the following assumptions can be made: (i) vehicles on a straight road move along the x-axis; (ii) vehicles on the same lane are placed equally likely along the y-axis; (iii) the horizontal and vertical positions of vehicles are independent of each other; (iv) there are countless vehicles on the infinitely long road; and (iv) the probability to be the transmitting vehicle or the receiving vehicle is same for all vehicles.

To analyze the spatial characteristics of a V2V channel, the spatial distribution of vehicles on a single lane road may be modeled. First, the distribution of vehicles along the y-axis is considered. The random variable Y denotes the vertical position of the antenna array of a vehicle on the lane. Assuming a Poisson mobility model in which all vehicles on the same lane are placed equally likely along the y-axis (of course, the present invention can be applied to other mobility models), Y follows a uniform distribution. Then, the PDF of Y is given by

$${f}_{Y} ( y ) = \frac{1}{w} , for 0 < y \leq w \qquad ( 4 )$$

where w denotes the width of a lane.

Next, the distribution of vehicles along the x-axis may be analyzed. According to the interval distribution model and the vehicle drop modeling in 3GPP TR 37.885, the horizontal distance between successive vehicles on the same lane follows an exponential distribution with an average distance Λ=vT, where v denoes the average speed of vehicle and T denotes the time gap.

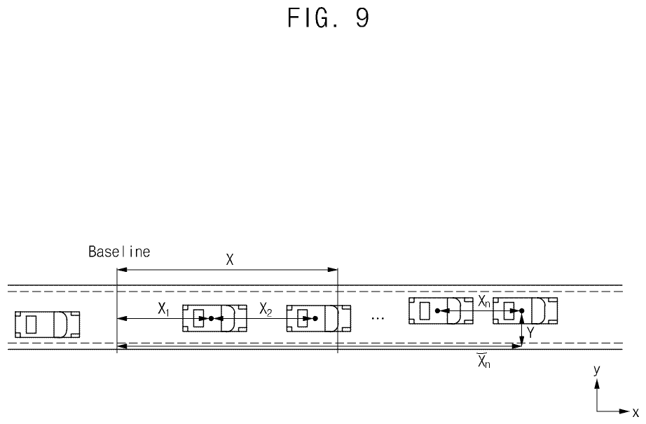

For further analysis, an arbitrary vertical line on the road, which serves as a baseline where the region of interest begins, may be considered. The baseline is indicated by a bold line in FIG. 9. The random variable Xₙ denotes the horizontal distance between the (n−1)-th vehicle and the n-th vehicle from the baseline (the random variable X₁ denotes the horizontal distance between the first vehicle and the baseline. The PDF of Xₙ is defined as

$${f}_{{X}_{n}} ( x ) = \frac{{e}^{- \frac{x}{Λ}}}{Λ} , for x \geq 0. \qquad ( 5 )$$

Let \dot{X}ₙ be a random variable representing the distance between the baseline and the antenna array of the n-th vehicle. This can be expressed as the sum of n independent exponential random variables, that is, \dot{X}ₙ=X₁+X₂++Xₙ, in Eq. (5). Since the sum of independent exponential random variables follows the Erlang distribution, the PDF of \dot{X}ₙ is defined by

$${f}_{{\tilde{X}}_{n}} ( \tilde{x} ) = \frac{{\tilde{x}}^{n - 1} {e}^{- \frac{x}{Λ}}}{{Λ}^{n} ( n - 1 ) !} , for \tilde{x} \geq 0. \qquad ( 6 )$$

Prior to the direct derivation of the distribution, the average number of vehicles located within a given interval (0, x] may be calculated. Assuming that U vehicles are dropped in a single lane, the average number of vehicles within the interval (0, x] can be determined by exploiting the Erlang random variable of Eq. (6). If the distance between the baseline and the n-th vehicle is equal to or shorter than x, at least n vehicles will be within the interval [0, x]. This event may be defined as Eₙ≐{\dot{X}ₙ≤x}. The probability that n vehicles are located within the interval [0, x], given that U vehicles are dropped, may be defined by

$$\begin{matrix}{P}_{( 0 , x \vert} ( n \vert U ) = P ( {E}_{n} ⋂ {E}_{n + 1}^{c} ) {=}^{( a )} P ( {E}_{n} ) - P ( {E}_{n + 1} ) \\ = P ( {\tilde{X}}_{n} \leq x ) - P ( {\tilde{X}}_{n + 1} \leq x )\end{matrix} , \qquad ( 7 )$$

where (a) is derived because Eₙ₊₁⊂Eₙ. It should be noted that E_{U+1} does not happen because only U vehicles are dropped along the x-axis. Therefore, it can be argued that P_{(0,x)}(U|U)=P(\dot{X}_{U}≤x) since P(\dot{X}_{U+1}≤x)=0.

The average number of vehicles located within the interval [0, x] is calculated by using the probability in Eq. (7), such that

$$\begin{matrix}{\tilde{U}}_{( 0 , x \vert} = {lim}_{U \to ∞} {\sum }_{n = 1}^{U} {nP}_{( 0 , x \vert} ( n \vert U ) \\ = {lim}_{U \to ∞} ( UP ( {E}_{U} ) + {\sum }_{n = 1}^{U - 1} n ( P ( {E}_{n} ) - P ( {E}_{n + 1} ) ) ) \\ = {lim}_{U \to ∞} {\sum }_{n = 1}^{U} P ( {E}_{n} ) = {lim}_{U \to ∞} {\sum }_{n = 1}^{U} {\int }_{0}^{x} \frac{{( \frac{x}{Λ} )}^{n - 1} {e}^{\frac{x}{Λ}}}{Λ ( n - 1 ) !} dt \\ {=}^{( a )} {lim}_{U \to ∞} {\sum }_{n = 1}^{U} {\int }_{0}^{\frac{x}{Λ}} \frac{{t}^{n - 1} {e}^{- t}}{( n - 1 ) !} dt \\ = {\int }_{0}^{\frac{x}{Λ}} {e}^{- t} {lim}_{U \to ∞} {\sum }_{n = 1}^{U} \frac{{t}^{n - 1}}{( n - 1 ) !} dt \\ {=}^{( b )} {\int }_{0}^{\frac{x}{Λ}} {e}^{- t} {e}^{t} dt = \frac{x}{Λ}\end{matrix} , \qquad ( 8 )$$

where (a) is derived by replacing

$$\frac{x}{Λ} = t ,$$

and (b) is derived based on the Taylor series expansion of

$${e}^{t} = {lim}_{N \to ∞} {\sum }_{n = 0}^{N} \frac{{t}^{n}}{n !} .$$

Furthermore, it may be also easy to show that the average number of vehicles between (a, b) is given by

$${\overline{U}}_{( a , b ]} = {\overline{U}}_{( 0 , b ]} - {\overline{U}}_{( 0 , a ]} = \frac{b - a}{Λ} \qquad ( 9 )$$

where the result increases in proportion to the length of the interval, b-a.

The results of Eqs. (8) and (9) indicate that the average number of vehicles increases proportionally with the length of the interval at a constant rate of 1/Λ. Therefore, it can be argued that the probability of a vehicle being present along the x-axis is uniform over the entire lane, and the average number of vehicles per unit length along the x-axis is 1/Λ. Similarly, according to Eq. (4), the probability of a vehicle being present along the y-axis is also uniform over the entire lane, and the average number of vehicles per unit length along the y-axis is 1/w. Based on this analysis, it can be concluded that every vehicles is uniformly placed throughout a single lane, and the average number of vehicles on a lane with an area A can be represented as A/wΛ. The average number of vehicles per unit area, 1/wΛ, is derived by multiplying the average number of vehicles per unit length along the x-axis, 1/Λ, by the average number of vehicles per unit length along the y-axis, 1/w.

Next, the channel directions between vehicles may be analyzed. Assuming that the average number of vehicles in a lane with an area A may be represented by A/wΛ, the angular distribution between vehicles may be derived by considering various realistic road structures. First, a straight road with L lanes may be considered, as shown in FIG. 8. The horizontal distance between successive vehicles on the l-th lane follows an exponential distribution with an average of [symbol] = [symbol] . Here, vₗ denotes the average speed of the vehicles on the l-th lane where l∈{1, 2, . . . , L}. Under this road condition, it is aimed to derive the PDF of the random variable Θ, which represents the azimuthal angle between the transmitting vehicle 12-1 and the receiving vehicle. The PDF of Θ may be defined by f_{Θ}(θ)=∫f_{Θ,\tilde{Y}}(θ,\tilde{y})d\tilde{y}=∫f_{Θ|\tilde{Y}}(Θ|\tilde{y})f_{\tilde{Y}}(\tilde{y})d\tilde{y}, where the random variable \tilde{Y} denotes the vertical position of the antenna array of the transmitting vehicle 12-1.

The PDF of Θ conditioned on \tilde{Y}=\tilde{y} may be derived by differentiating the CDF of Θ conditioned on \tilde{Y}=\tilde{y} with respect to θ. To obtain the CDF, the following V2V communication scenario may be considered. Among all the vehicles on a road, one vehicle is randomly selected as the transmitting vehicle 12-1, with its vertical position denoted as \tilde{Y}=\tilde{y}. The transmitting vehicle 12-1 may try to communicate with an arbitrary vehicle within a circular communication area, represented by the green circle in FIG. 8, where the radius of the communication area is denoted as R, where the communication area delineates the region where the transmitting vehicle primarily needs to establish V2V communication. The receiving vehicle is then attempts to communicate with a random vehicle within the communication area. The receiving vehicle is then randomly chosen from the vehicles within the communication area.

The CDF of Θ conditioned on \tilde{Y}=\tilde{y} can be obtained by utilizing the average number of vehicles within an angular interval (0, θ] of the communication area. Note that the angular interval (0, θ] represents the circular sector of the communication area with a sector angle θ∈(0, 2π]. To derive it, [symbol] (0,\tilde{y}) is defined as the area where the l-th lane intersects with the communication area within the angular interval (0, θ]. Based on the analytical studies above, the average number of vehicles within [symbol] (θ,\tilde{y}) can be calculated as

$$\text{?}$$

$$\text{?} \text{indicates text missing or illegible when filed}$$

Thus, the average number of vehicles within the angular interval (0, θ] of the communication area is represented as

$${\sum }_{ℓ = 0}^{L} \text{?} .$$

$$\text{?} \text{indicates text missing or illegible when filed}$$

The CDF of Θ conditioned on \tilde{Y}=\tilde{y} can then be derived as

$${F}_{Θ \vert \tilde{Y}} ( θ \vert \tilde{y} ) = \text{?} \qquad ( 10 )$$

$$\text{?} \text{indicates text missing or illegible when filed}$$

In order to derive [symbol] (2π, \tilde{y}), it is necessary to calculate the area where the l-th lane intersects with the entire communication area. To simplify the computation, it is assumed that R is much longer than the total width of the lane wL, i.e., R>>wL. Under this assumption, [symbol] (2π,\tilde{y}) can be approximated as 2Rw. This approximation can be intuitively understood as when R becomes much longer than wL, each crossroad can be treated as a rectangle with a height of w and a base of 2R. From now on, the crossroad between the l-th lane and the entire communication area may be approximated as a rectangle with an area of 2Rw, i.e., [symbol] (2π,\tilde{y})≅2Rw. By employing this approximation, the CDF of Θ conditioned on \tilde{Y}=\tilde{y} can be approximated as

$${F}_{Θ \vert \tilde{Y}} ( θ \vert \tilde{y} ) = \text{?} \qquad ( 11 )$$

$$\text{?} \text{indicates text missing or illegible when filed}$$

[symbol] (θ,\tilde{y}) can be calculated by summing up the areas of the crossroads where the l-th lane and the communication area within the angular interval (0, θ] overlap. For example, [symbol] (0,\tilde{y}) is (½) R² tan θ for w( [symbol] −1)<\tilde{y}≤w [symbol] and

$$0 < θ \leq {tan}^{- 1} ( \frac{w ℓ - \tilde{y}}{R} ) .$$

This is because the crossroad is a right triangle with a height of R tan θ and a base of R. By combining the result in Eq. (11) with the partial derivative of [symbol] (0,\tilde{y}) with respect to θ, i.e.,

$$\text{?}$$

$$\text{?} \text{indicates text missing or illegible when filed}$$

the PDF of Θ conditioned on \tilde{Y}=\tilde{y} can be approximated as

$${f}_{Θ \vert \tilde{Y}} ( θ \vert \tilde{y} ) = \frac{\partial {F}_{Θ \vert \tilde{Y}} ( θ \vert \tilde{y} )}{\partial θ} ≃ \text{?} \qquad ( 12 )$$

$$\text{?} \text{indicates text missing or illegible when filed}$$

Note that

$$\text{?}$$

$$\text{?} \text{indicates text missing or illegible when filed}$$

is summarized in (13).

$$\text{?} = i ) For 0 < \hat{y} \leq w ( ℓ - 1 ) , \\ \{ \begin{matrix}0 , & \text{?} \\ \frac{1}{2} w ( w ( 2 ℓ - 1 ) - 2 \text{?} ) {cos}^{2} ( θ ) , & \text{?} \\ \frac{1}{2} ( {R}^{2} {sec}^{2} ( θ ) - {( w ( t - 1 ) - \text{?} )}^{2} {csc}^{2} ( θ ) ) , & otherwise\end{matrix} . \\ ii ) For w ( ℓ - 1 ) < \text{?} \leq w ℓ , \\ \{ \begin{matrix}\frac{1}{2} \text{?} & \text{?} \\ \frac{1}{2} \text{?} & \text{?} \\ \frac{1}{2} {R}^{2} {sec}^{2} ( θ ) , & otherwise\end{matrix} . \\ iii ) For w ℓ < \text{?} \leq wL , \\ \{ \begin{matrix}0 , & \text{?} \\ \frac{1}{2} \text{?} & \text{?} \\ \frac{1}{2} \text{?} & otherwise\end{matrix} . \qquad ( 13 )$$

$$\text{?} \text{indicates text missing or illegible when filed}$$

The PDF of \tilde{Y} can be derived by differentiating the CDF of \tilde{Y} with respect to \tilde{y}. The CDF of \tilde{Y} can be obtained by considering the average number of vehicles within the vertical interval (0,\tilde{y}]. Note that the vertical interval (0, \tilde{y}] represents a rectangle with a base of 2R and a height of \tilde{y}∈(0, wL]. For w( [symbol] −1)<\tilde{y}≤w [symbol] , the average number of vehicles within (0,\tilde{y}] can be calculated by summing up the average number of vehicles on the first to l-th lane. The average number of vehicles on the first to (l-1)-th lane is approximated as

$$\frac{2 Rw}{w {Λ}_{1}} , … , \frac{2 Rw}{\text{?}} .$$

$$\text{?} \text{indicates text missing or illegible when filed}$$

Additionally, the average number of vehicles on the l-th lane is approximated as

$$\frac{2 R ( \overline{y} - w ( ℓ - 1 ) )}{\text{?}} ,$$

$$\text{?} \text{indicates text missing or illegible when filed}$$

considering that the vehicles on the l-th lane can only be placed within the vertical interval w( [symbol] −\tilde{y}]. By following a similar approach, the average number of vehicles within (0, wL] can be approximated as

$$\text{?}$$

$$\text{?} \text{indicates text missing or illegible when filed}$$

Therefore, the CDF of \tilde{Y} can be approximated as

$$\text{?}$$

$$\text{?} \text{indicates text missing or illegible when filed}$$

for w( [symbol] −1)<\tilde{y}≤w [symbol] .

This approximation leads to the approximated PDF of \tilde{Y} expressed as

$$\text{?} \qquad ( 14 )$$

$$\text{?} \text{indicates text missing or illegible when filed}$$

Finally, the PDF of Θ is approximated as

$$\text{?} \qquad ( 15 )$$

$$\text{?} \text{indicates text missing or illegible when filed}$$

where (a) is derived from Eq. (12) and (b) is derived from Eq. (14).

Next, having described the analysis of the channel orientation between vehicles in various road structures, the spatial characteristics of various road structures such as crossroads, T-corners, and L-corners may be analyzed using a similar process. Consider a straight road with L lanes and an intersecting road with L_{I} lanes, intersecting at an angle of θ_{I} as illustrated in FIG. 8. Here, the intersecting road is assumed to be connected to the edge of the straight road. The distance between each successive vehicle on the [symbol] _{I}∈{1,2, . . . , L_{I}}th lane follows an exponential distribution with an average of [symbol] = [symbol] T, where [symbol] denotes the average speed of vehicles on the [symbol] -th lane.

The PDF of Θ is defined by

$$\text{?}$$

$$\text{?} \text{indicates text missing or illegible when filed}$$

where (a) is derived from the assumption that the horizontal and vertical positions of the vehicle are independent of each other. The random variable \tilde{X} denotes the difference between the horizontal position of the antenna array of the transmitting vehicle and the intersecting point where the straight road and the intersecting road meet. The PDF of Θ conditioned on (\tilde{X}, \tilde{Y})=(\tilde{x}, \tilde{y}) is derived as

$$\text{?}$$

$$\text{?} \text{indicates text missing or illegible when filed}$$

where [symbol] (θ, \tilde{x}) denotes the area where the [symbol] -th lane intersects with the communication area within the angular interval (0, θ].

$$\text{?}$$

$$\text{?} \text{indicates text missing or illegible when filed}$$

and [symbol] (2π, \tilde{x}) for the case of crossroad may be derived as an example of the proposed framework, and the summary of

$$\text{?}$$

$$\text{?} \text{indicates text missing or illegible when filed}$$

and [symbol] (2π, \tilde{x}) is presented in Eqs. (17) and (18), respectively.

$$\text{?} \qquad ( 17 )$$

$$\text{?} \qquad ( 18 )$$

$$\text{?} \text{indicates text missing or illegible when filed}$$

In Eqs. (17) and (18), we let [symbol] =\tilde{x}−w( [symbol] −1),

$$\text{?}$$

$$\text{?} \text{indicates text missing or illegible when filed}$$

for simplicity. It is noteworthy that

$$\text{?}$$

$$\text{?} \text{indicates text missing or illegible when filed}$$

and [symbol] (2π, \tilde{x}) for any kind of road structure can be calculated using same methodology as in Eqs. (13), (17), and (18). For example,

$$\text{?}$$

$$\text{?} \text{indicates text missing or illegible when filed}$$

and [symbol] (2π, \tilde{x}) may be calculated to derive f_{Θ}(θ) for a T-corner for θ_{I}=π/2 or example, 3π/2. To be specific,

$$\text{?}$$

$$\text{?} \text{indicates text missing or illegible when filed}$$

in (17) may be set to be zero for π<θ≤2π when θ_{I}=π/2, and for 0<θ≤π when θ_{I}=3π/2, and [symbol] (2π, \tilde{x}) in Eq. (18) may be set to be half.

It may be assumed that X follows a uniform distribution, as the average number of vehicles within the horizontal interval \tilde{x}∈(−R, R+wL] is proportional to the length of the interval as shown in Eq. (9). Here, the range of \tilde{x} is determined by the communication area of the transmitting vehicle, which starts to overlap with the intersecting road when \tilde{x}=−R and leaves when \tilde{x}=R+wL. Therefore, the PDF of \tilde{X} is expressed as Eq. (19),

$$\text{?} \qquad ( 19 )$$

$$\text{?} \text{indicates text missing or illegible when filed}$$

Finally, the PDF of Θ may be approximated as

$$\text{?} \qquad ( 20 )$$

$$\text{?} \text{indicates text missing or illegible when filed}$$

where (a) is derived from Eq. (19) and (b) is derived from Eq. (16).

The inclusion of roundabouts within crossroads may be considered. The transmitting vehicle may be located either inside or outside of the roundabout. In both cases, the PDF of θ can be derived using a similar method in Eqs. (15) and (20). However, due to safety regulations limiting the size of roundabouts, their geometry has limited effects on the PDF of θ. Therefore, when the transmitting vehicle is located outside of the roundabout, it may be possible to ignore the impact of the roundabout when deriving the PDF of θ Additionally, when the transmitting vehicle is located inside the roundabout, the PDF of θ follows a uniform distribution, as the heading direction of the transmitting vehicle within the roundabout is uniformly distributed.

Referring again to the flowchart of FIG. 4, the operation control unit 40 may set beamwidths of the beam pattern to be generated by codewords in the codebook based on the obtained vehicle distribution function such as CDF or PDF (step S300). The method of setting the beamwidth is to divide the entire angular range of the azimuth centered on the transmitting vehicle into a plurality of angles of the beamwidth, and particularly angles of the plurality of beam widths can be set such that the average number of vehicles that will probabilistically exist within each divided angle range is the same. That is, based on the CDF or PDF obtained according to each road environment, a code word may be designed to generate a beam pattern that has a relatively thin beam width in a direction where the probability of vehicle existing is high, and a relatively wide beam width in a direction where the probability of vehicle existing is low.

To explain this more specifically theoretically, an example embodiment of the present invention may construct a codebook consisting of Qₜ codewords based on the statistical distribution of angle between vehicles. The first step of our codebook design framework is to define the beamwidth for each codeword. The objective of the beamwidth allocation process is to ensure that the average number of received vehicles within the angular range of each codeword is identical. Considering the sectorization of two ULAs each covering and Θ∈v^{h} and Θ∈v^{b}, and the asymmetric nature of the statistical distribution of angle between vehicles, it is needed to design codebooks for two ULAs, respectively. In the algorithm according to the example embodiment, the angular range of the qₜ-th codeword,

$${v}_{{Q}_{t}}^{AD} = ( {θ}_{qt - 1} , {θ}_{qt} ]$$

for qₜ∈{1, . . . , Qₜ}, is designed to satisfy

$${\int }_{{θ}_{qt - 1}}^{{θ}_{qt}} {f}_{⊖} ( θ ) d θ = \{ \begin{matrix}\frac{{\int }_{{θ}_{0}}^{{θ}_{{Q}_{t} / 2}} {f}_{⊖} ( θ ) d θ}{{Q}_{t} / 2} , & for {q}_{t} ∈ \{ 1 , … , \frac{{Q}_{t}}{2} \} , \\ \frac{{\int }_{{θ}_{{Q}_{t} / 2}}^{{θ}_{{Q}_{t}}} {f}_{⊖} ( θ ) d θ}{{Q}_{t} / 2} , & for {q}_{t} ∈ \{ \frac{{Q}_{t}}{2} + 1 , … , {Q}_{t} \} ,\end{matrix} \qquad ( 21 )$$

where θ₀=3π/2,

$${θ}_{{Q}_{t} / 2} = \frac{π}{2} and {θ}_{{Q}_{t}} = \frac{3 π}{2} .$$

The angular domain in Eq. (21) may be transformed into the spatial frequency domain, denoted as

$${v}_{{q}_{t}}^{SFD} = ( π sin {θ}_{{q}_{t} - 1} , π sin {θ}_{{q}_{t}} ] .$$

This transform is possible because the spatial frequency of the angular direction is defined by ψ=sin θ. The beamwidth allocation strategy according to the example embodiment allows to assign narrow beams to directions with a high number of vehicles, while assigning broad beams to directions with a lower number of vehicles.

The next step is to define an ideal beam pattern for each codeword using the predefined beamwidth

$${v}_{{q}_{t}}^{AD} ,$$

where qₜ∈{1, . . . , Qₜ/2}, for ULA directing θ∈v^{h}. Note that the same process is applied when designing the codebook directing θ∈v^{b}. In the example embodiment, the q^{t}-th ideal codeword generating a normalized beamforming gain T_{q}_{ₜ} for

$$θ ∈ {v}_{{q}_{t}}^{AD}$$

and a zero beam forming gain for

$$θ ∈ {v}^{h} \backslash {v}_{{q}_{t}}^{AD}$$

may be considered. Therefore, the ideal beam pattern is defined as

$$G ( ψ , {f}_{{q}_{t}}^{ideal} ) \dot{=} {\vert {( {f}_{{q}_{t}}^{ideal} )}^{H} {a}_{{M}_{t}} ( θ ) \vert}^{2} = \{ \begin{matrix}{τ}_{{q}_{t}} , & θ ∈ {v}_{{q}_{t}}^{AD} , \\ 0 , & θ ∈ {v}^{h} \backslash {v}_{{q}_{t}}^{AD} .\end{matrix} \qquad ( 22 )$$

In Eq. (22),

$${f}_{{q}_{t}}^{ideal}$$

represents the qₜ-th ideal transmit codeword which is configured based on the codeword design algorithm. According to Parseval's theorem, the flattened beamforming gain is derived as

$$\begin{matrix}{\int }_{- π}^{π} G ( ψ , {f}_{{q}_{t}}^{ideal} ) d ψ & = {\int }_{{v}_{{q}_{t}}^{SFD}} {τ}_{{q}_{t}} d ψ + {\int }_{[ - π , π ) \backslash {v}_{{q}_{t}}^{SFD}} 0 d ψ \\ & = {τ}_{{q}_{t}} {v}_{{q}_{t}}^{SFD} = \frac{2 π}{{M}_{t}} .\end{matrix} .$$

As the flattened beamforming gain is determined by the number of antennas and the beamwidth of the ideal codeword, the gain can be greater than one. However, since the normalized beamforming gain cannot be greater than one, any flattened beamforming gain that exceeds one needs to be truncated. Therefore, the flattened beamforming gain for the qᵣ-th ideal codeword is given by

$${τ}_{{q}_{t}} \dot{=} min \{ 1 , \frac{2 π}{{M}_{t} {v}_{{q}_{t}}^{SFD}} \} .$$

In the example embodiment, it may be assumed that a large number of antennas are employed. Also, it may be assumed that the codebook consists of a small number of codewords, which results in a broader

$${v}_{{q}_{t}}^{SFD} .$$

Under these assumptions,

$${τ}_{{q}_{t}} = \frac{2 π}{{M}_{t} {v}_{{q}_{t}}^{SFD}} \leq 1$$

is satisfied for all codewords, and no truncation is required.

After the beam width is set as described above, the operation control unit 40 may design codewords optimized for the hardware of the V2V communication system installed in the vehicle based on the ideal beam pattern that generates the beamwidths set (step S400). In this step, a set of codewords optimized thereto may be constructed by considering an architecture of a hybrid beamforming system 200, in particular, the number of RF chain units 130t, 130r and antenna arrays 110t, 110t and their connections. To compute an actual beamforming codeword

$${f}_{{q}_{t}}^{opt} = {F}_{RF , {q}_{t}}^{opt} {f}_{BB , {q}_{t}}^{opt} ,$$

which generates a beam pattern similar to the ideal beam pattern mentioned in Eq. (22), it is needed to focus on solving the optimization problem, Eq. (23),

$$( {F}_{RF , {q}_{t}}^{opt} , {f}_{BB , {q}_{t}}^{opt} ) = {arg min}_{{F}_{RF , {q}_{t}} , {f}_{BB , {q}_{t}}} {‖ {f}_{{q}_{t}}^{ideal} - {F}_{RF , {q}_{t}} , {f}_{BB , {q}_{t}} ‖}_{2} \qquad ( 23 )$$

$$s . t . {‖ {F}_{RF , {q}_{t}} {f}_{BB , {q}_{t}} ‖}_{2}^{2} = 1.$$

However, it is difficult to solve the above optimization problem in a closed form. Therefore, the sub-optimal solution to Eq. (23), (F_{RF,qt},f_{BB,qt}), may be obtained based on the codeword design algorithm. In an example embodiment, the given codeword design algorithm may design a codeword that generates the set beamwidth using an OPM algorithm. The finite resolution phase shifters may be considered when establishing the set of RF beam steering vectors of qₜ-th codeword F_{RF,q}_{ₜ}. By assembling Qᵥ codewords, the beamforming codebook may be constructed as [symbol] ={f₁, . . . , f_{Q}_{ₜ}}, where the qₜ-th transmit codeword is defined by f_{qt}=F_{RF,q}_{ₜ} f_{BB,q}_{ₜ}. Following similar codeword design process, it is also possible to construct the combining codebook, [symbol] ≐{w₁, . . . , w_{Q}_{ᵣ}}, consisting of Qᵥ receiving codewords.

In the operation control unit 40, the codewords generated by this design method may be combined into a codebook (step S500). The codebook thus obtained can be utilized with the help of a roadside unit (RSU) placed along a road for V2I communication. This transmission infrastructure has the function of identifying the configuration of adjacent roads, such as road structure and number of lanes. The codebook design apparatus 30, for example, in the RSU can design a proposed codebook by combining data on the road structure and the expected average speed of vehicles, and broadcast the codebook to neighboring vehicles. The neighboring vehicles that receive the codebook may perform V2V communication based on the received codebook.

As described above, the present invention provides a codebook design technique that takes into account the communication environment of a V2V network. First, a model capable of capturing the statistical characteristics of directional communication in a V2V network is developed by analyzing the angle distribution between two vehicles in various road structures such as straight roads, crossroads, and roundabouts, and this angle distribution model is used to adjust the beam width of each codeword so that the average number of vehicles within the coverage of each codeword is the same. According to this beam width adjustment criterion, a sharp beam is assigned to the direction where the most vehicles are likely to exist, and a wide beam is assigned to the direction where the least vehicles are likely to exist. After assigning the beam width for each codeword, a codebook may be configured based on a predetermined algorithm.

Since the codebook design technique according to the embodiments described above is a method that relies on the statistical distribution of angles, it is necessary to prove that the approximate PDF of Θ according to the example embodiment of the present invention accurately represents the empirical PDF. In order to obtain numerical results, several vehicles were simulated in a complex urban grid road environment shown in FIG. 6 according to the vehicle mobility model. After selecting a transmitting vehicle from all vehicles on the road, a receiving vehicle is randomly selected within the communication range R, and then the angle between the antenna arrays of the transmitting vehicle and the receiving vehicle can be calculated. This process is repeated 10,000 times to obtain the empirical PDF of Θ through the Monte Carlo method.

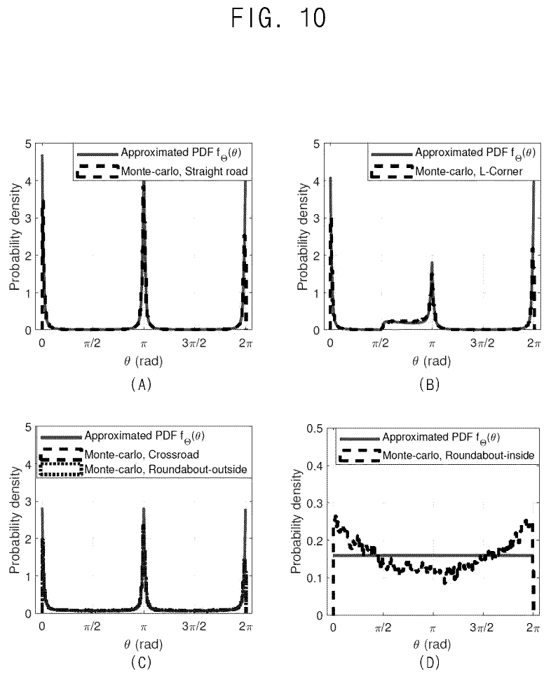

FIG. 10 shows comparisons of the approximate PDF obtained according to the present invention and the empirical PDF obtained according to the prior art for various road structure types.

As shown in FIG. 10, it can be seen that the approximate PDF (represented by a solid line) is almost identical to the empirical PDF (represented by a dotted line), which indicates that the approximate PDF according to the present invention is reasonable. When the transmitting vehicle is on the straight road, the probability of finding the vehicle is highest around θ=0, π and lowest around θ=π/2, 3π/2, as shown in FIG. 10(A). This distribution is because vehicles move along the x-axis. Conversely, since the total width of the road wL is much shorter than the length of the road within the communication range R, the space in which the vehicle can move is much more limited along the y-axis. Therefore, more vehicles are observed at θ=0, π, and the probability decreases at θ=π/2, 3π/2. This tendency becomes weaker when considering intersecting roads, so that the probability density of vehicles in L-shaped roads and cross-shaped intersections (including the roads outside the roundabout) such as in FIGS. 10(B) and (C) becomes higher. When the transmitting vehicle is inside the roundabout, the empirical PDF shows a slight discrepancy from the uniform distribution as in FIG. 10(D). This is mainly due to the slight geometric asymmetry of the roundabout within the intersection, which can be seen as making a slight difference in the average number of vehicles heading in the forward and orthogonal directions.

According to an example embodiment of the present invention, a codebook can be constructed using a spatial distribution-based beam design scheme by utilizing the approximate PDF. The most notable feature of the codebook is that the adaptive beamwidth changes depending on the angle. When the transmitting vehicle is located on a straight road, the beam pattern directed toward θ=0, x becomes narrow, and the beam pattern directed toward θ=π/2, 3π/2 becomes wide. This is because the proposed codebook is designed in such a way that the beamwidth becomes narrower in areas with many vehicles and wider in areas with few vehicles. This design principle may be also applied when designing a codebook that considers crossroads.

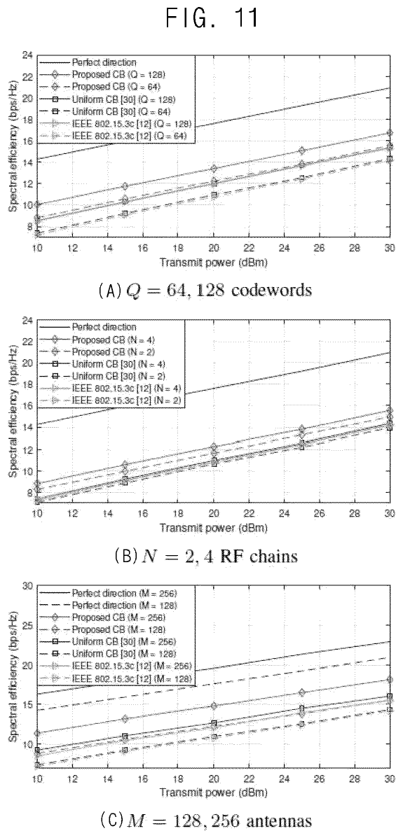

FIG. 11 shows change of the frequency efficiency according to the numbers of codewords, RF chains, and antennas.

It is shown in FIG. 11(A), that the spectral efficiency increases as the number of codewords increases. Employing a large number of codewords enables more precise beam-alignment with sharper beam patterns, resulting in higher spectral efficiency. In most cases, the transmitting vehicle and the receiving vehicle align along the x-axis rather than the y-axis. Since the codebook according to the example embodiments uses a codeword with higher beam forming gain around θ=0 compared to θ=π/2, 3π/2, it is possible to exploit higher gain for most cases. Also, as the number of RF chains N and the number of antennas M increase, higher spectral efficiency can be achieved as demonstrated in FIG. 11(B) and FIG. 11(C). When more RF chains and antennas are used, much ideal beam pattern can be constructed under the hybrid beam forming structure. With well-constructed beam patterns, every angular domain can be ideally covered and this results in better performance.

The codebook according to the beam pattern design method of the present invention described above can be used in the V2V communication system. Since a narrow beam can be allocated to a direction with many vehicles and a wide beam can be allocated to a direction with few vehicles, a better data transmission rate performance can be obtained than the conventional codebooks in the V2V communication scenario. Furthermore, since the present invention is a methodology for designing a codebook having different beam widths depending on the angular distribution between a transmitter and a receiver, it can be applied to other communication fields as well as the field of V2V communication.

Although the embodiments have been described with reference to limited drawings, it will be understood by those skilled in the art that various modifications and changes can be made to the present invention without departing from the spirit and scope of the present invention as set forth in the claims below. For example, suitable results can be achieved even if the described techniques are performed in a different order than the described method, and/or components of the described systems, structures, devices, circuits, etc. are combined or combined in a different form than the described method, or are replaced or substituted by other components or equivalents. Therefore, other implementations, other embodiments, and equivalents of the claims also fall within the scope of the claims set forth below.

What is claimed is:

1. A method of designing a codebook for wireless communication between vehicles by executing a codebook design program in a codebook design apparatus, comprising:
obtaining a vehicle distribution function representing distribution of vehicles on a road based on a road structure, traffic parameter information, a mobility model, and a communication range R required for V2V communication;
setting a beam width of a beam pattern to be generated by each codeword of a codebook based on the obtained vehicle distribution function; and
designing codewords optimized for hardware of a V2V communication system installed in each of vehicles on a road based on an ideal beam pattern that generate the set beam width.

2. The method of claim 1, wherein the vehicle distribution function is a cumulative distribution function (cdf) or a probability density function (pdf) of vehicles existing on the road.

3. The method of claim 1, wherein the ‘obtaining a vehicle distribution function’ comprises obtaining an average number of vehicles existing within a circle with a radius R centered on a transmitting vehicle on a road by applying a mobility model expressed by specific traffic parameters; obtaining an average number of vehicles existing within a sector area with the radius R and a central angle of θ centered on the transmitting vehicle; and obtaining the CDF representing a probability that vehicles exist within the central angle θ centered on the transmitting vehicle by dividing the average number of vehicles existing within the sector area by the average number of vehicles existing within the circle.

4. The method of claim 3, wherein the ‘obtaining the vehicle distribution function’ further comprises obtaining the PDF representing a distribution probability density of vehicles according to the central angle θ by partially differentiating the obtained CDF with respect to the central angle θ of the sector area.

5. The method of claim 4, wherein the CDF and/or the PDF are/is obtained separately for a plurality of road structures including a straight road, a L-corner road, a T-corner road, a crossroad, and a roundabout.

6. The method of claim 1, wherein the ‘setting a beamwidth of a beam pattern’ comprises setting a relatively thinner beam width in a direction in which a probability of vehicle existence is relatively high, and a relatively wider beam width in a direction in which the probability of vehicle existence is relatively low, based on the CDF according to the central angle θ.

7. The method of claim 1, further comprising constructing a codebook by grouping codewords designed in the designing codewords into the codebook.

8. The method of claim 1, wherein the ‘setting a beamwidth of a beam pattern’ comprises dividing an entire angular range of azimuth into a plurality of beam width angles centered on the transmitting vehicle, and setting the plurality of beam width angles such that all average numbers of vehicles existing probabilistically within respective angular ranges of all divided angles are the same.

9. The method of claim 8, wherein the codeword that generates the set beam width is designed using an orthogonal propagation method (OPM) algorithm.

10. The method of claim 1, wherein the traffic parameter information is information obtained by a sensor unit of the codebook design apparatus sensing and analyzing a traffic situation of vehicles on surrounding roads in real time.

11. A codebook design apparatus applicable to a vehicle to vehicle (V2V) wireless communication, comprising:
a vehicle detection sensor unit configured to sense traffic conditions of vehicles on surrounding roads in real time;
a storage unit configured to store a codebook design program, traffic parameter data detected by the vehicle detection sensor unit, information set with respect to a structure of surrounding roads, a mobility model, and communication range R required for the V2V wireless communication; and
an operation control unit configured to execute the codebook design program for performing tasks of obtaining a vehicle distribution function representing distribution of vehicles on a road based on the traffic parameter data detected in real time, and the information set with respect to a structure of surrounding roads, a mobility model, and communication range R; setting a beam width of a beam pattern to be generated by each codeword of a codebook based on the obtained vehicle distribution function; and designing codewords optimized for the hardware of a V2V communication system installed on vehicles on the road based on an ideal beam pattern that creates the set beam width, so that the codebook is adaptively designed according to the road structure and traffic conditions.

12. The codebook design apparatus of claim 11, further comprising a communication unit configured to support wireless communication with wireless communication systems installed in vehicles on surrounding roads, wherein the operation control unit is configured to execute the codebook design program for further performing tasks of grouping designed codewords to construct a codebook and broadcasting the codebook to vehicles on surrounding roads through a communication unit so that the codebook can be applied to the vehicles.

13. The codebook design apparatus of claim 11, wherein the vehicle distribution function is a CDF or a PDF of vehicles existing on the road.

14. The codebook design apparatus of claim 11, wherein the ‘obtaining a vehicle distribution function’ comprises obtaining an average number of vehicles existing within a circle with a radius R centered on a transmitting vehicle on a road by applying a mobility model expressed by specific traffic parameters; obtaining an average number of vehicles existing within a sector area with the radius R and a central angle of θ centered on the transmitting vehicle; and obtaining the CDF representing a probability that vehicles exist within the central angle θ centered on the transmitting vehicle by dividing the average number of vehicles existing within the sector area by the average number of vehicles existing within the circle.

15. The codebook design apparatus of claim 14, wherein the ‘obtaining the vehicle distribution function’ further comprises obtaining the PDF representing a distribution probability density of vehicles according to the central angle θ by partially differentiating the obtained CDF with respect to the central angle θ of the sector area.

16. The codebook design apparatus of claim 15, wherein the CDF and/or the PDF are/is obtained separately for a plurality of road structures including a straight road, a L-corner road, a T-corner road, a crossroad, and a roundabout.

17. The codebook design apparatus of claim 11, wherein the ‘setting a beamwidth of a beam pattern’ comprises setting a relatively thinner beam width in a direction in which a probability of vehicle existence is relatively high, and a relatively wider beam width in a direction in which the probability of vehicle existence is relatively low, based on the CDF according to the central angle θ.

18. The codebook design apparatus of claim 11, wherein the ‘setting a beamwidth of a beam pattern’ comprises dividing an entire angular range of azimuth into a plurality of beam width angles centered on the transmitting vehicle, and setting the plurality of beam width angles such that all average numbers of vehicles existing probabilistically within respective angular ranges of all divided angles are the same.
